(19) United States
(12) Patent Application Publication
(10) Pub. No.: US 2012/0038260 A1
(43) Pub. Date: Feb. 16, 2012

(54) LAMP ENVELOPE AND LED LAMP USING THE SAME

(75) Inventors: YING-CHIEH LU, Chu-Nan (TW); KUO-FENG CHIANG, Chu-Nan (TW); ZHENG-JAY HUANG, Chu-Nan (TW); KUO-MANG LO, Chu-Nan (TW); HSIN-FEI HUANG, Chu-Nan (TW); YU-SHU CHEN, Chu-Nan (TW)

(73) Assignee: FOXSEMICON INTEGRATED TECHNOLOGY, INC., Chu-Nan (TW)

(21) Appl. No.: 12/915,031

(22) Filed: Oct. 29, 2010

(30) Foreign Application Priority Data
Aug. 13, 2010 (TW) 99127052

(51) Int. Cl. F21V 29/00; H01J 5/02

(52) U.S. Cl. 313/45; 174/50

(57) ABSTRACT

An LED lamp includes a lamp holder, a heat sink, a light source and an envelope. The lamp holder is configured for electrically connecting with a power source. The heat sink is connected to the lamp holder. The light source is mounted on the heat sink. The envelope is mounted on the heat sink and covers the light source. The envelope has a light incident surface and a light output surface opposite to the light incident surface. A plurality of lens are formed on the lamp envelope and configured for collecting light rays generated by the light source.

### BACKGROUND

1. Technical Field

The present disclosure relates generally to lamps, and more particularly to a lamp having an envelope which improves heat dissipating efficiency of the lamp.

2. Description of Related Art

Usually, a lens is integrally formed with an LED (light emitting diode) package used as a light source of an LED lamp. However, the lens is directly located on the LED package and encapsulates the LED package thereby decreasing heat dissipating efficiency of the LED package and shortening a lifespan of the LED package.

What is needed therefore is a lamp having an envelope which can overcome the above limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views.

FIG. 1 is an isometric, assembled view of an LED lamp in accordance with an embodiment of the present disclosure.

FIG. 2 is an isometric, exploded view of the LED lamp in FIG. 1.

FIG. 3 is an enlarged, cross-sectional view of a part of the LED lamp in FIG. 1.

FIG. 4 is an enlarged, cross-sectional view of a part of a LED lamp in accordance with another embodiment of the present disclosure.

### DETAILED DESCRIPTION

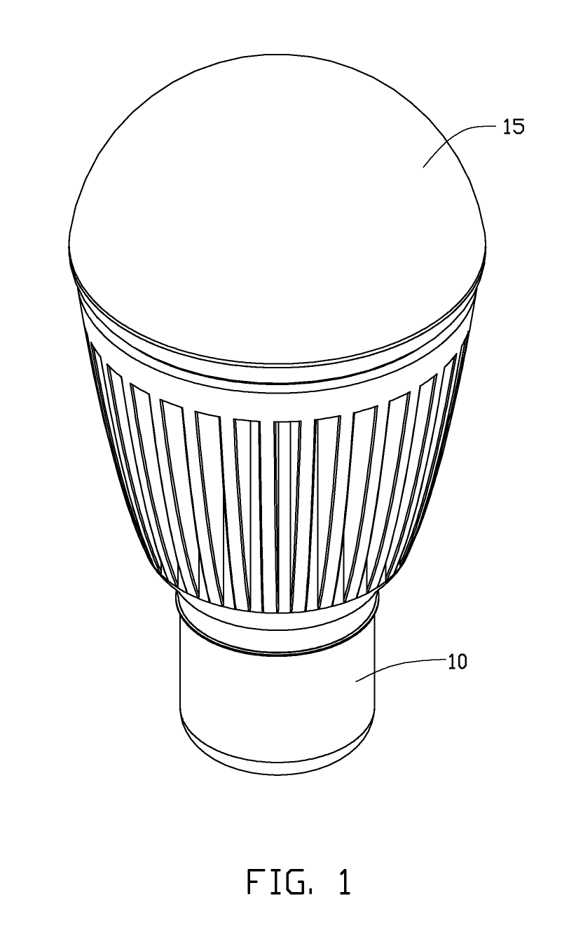

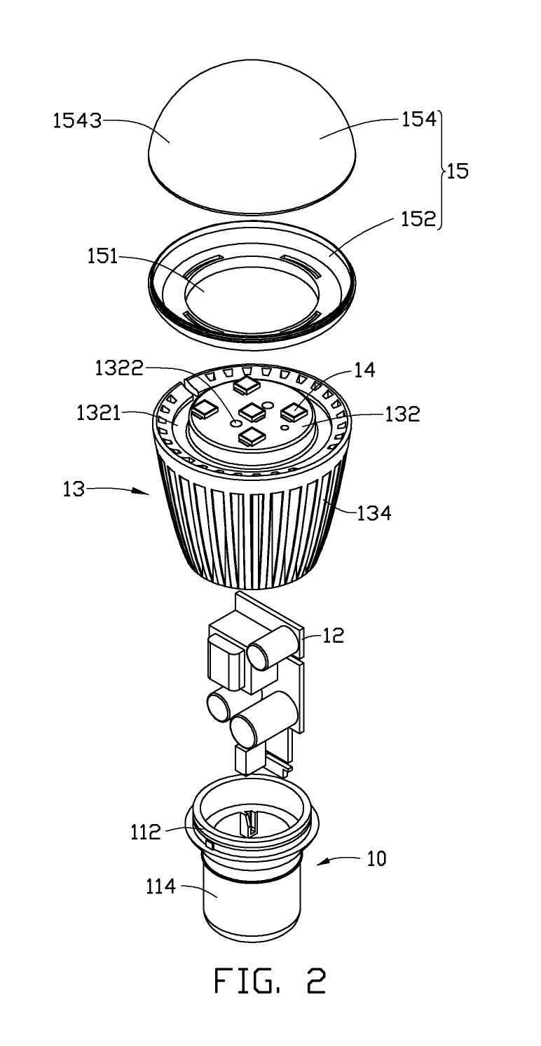

As shown in FIGS. 1-2, an LED lamp in accordance with an embodiment of the present disclosure comprises a lamp holder 10, a heat sink 13 connected to the lamp holder 10, a driving circuit 12 accommodated in the heat sink 13, a light source 14 mounted on the heat sink 13, and a lamp envelope 15 mounted on the heat sink 13 and covering the light source 14.

The lamp holder 10 comprises a securing portion 112 and an electrical connector 114. The electrical connector 114 is secured to an end of the securing portion 112, and is configured for connecting to a power source (not shown) which can supply power to the LED lamp. The securing portion 112 is configured for securely connecting with the heat sink 13 to accommodate the driving circuit 12 in the lamp holder 10 and the heat sink 13. The electrical connector 114 is configured to be inserted into a standard socket for a conventional incandescent bulb or compact fluorescent lamp which is electrically connected with the power source, whereby the LED lamp in accordance with the present disclosure can replace the conventional incandescent bulb or compact fluorescent lamp.

The driving circuit 12 is disposed in the heat sink 13 and the lamp holder 10, and is electrically connected to the electrical connector 114 and the light source 14. The driving circuit 12 is configured for providing driving voltage for the light source 14.

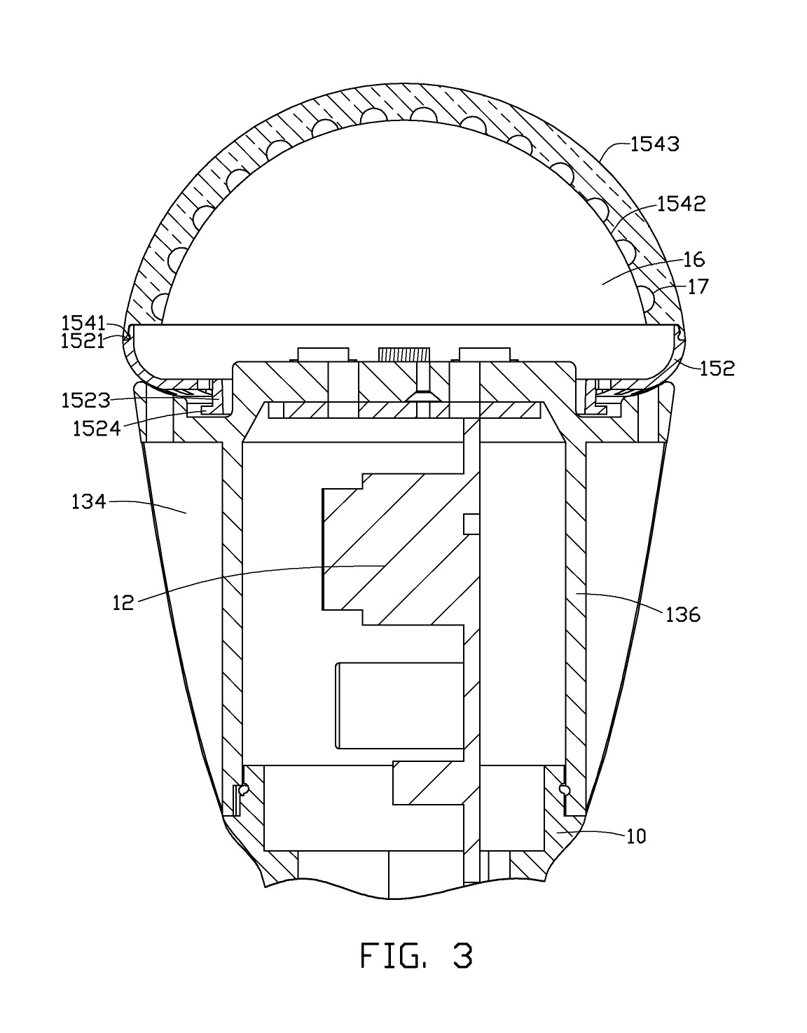

Also referring to FIG. 3, the heat sink 13 includes a base 132, a number of fins 134, and a hollow post 136. The base 132 comprises a top surface facing away from the lamp holder 10 and a bottom surface opposite to the top surface. The light source 14 is directly mounted on the top surface of the base 132. The base 132 is made of thermally conductive and electrically insulating material, such as ceramics. The ceramics can be selected from a group consisting of alumina ceramics, aluminum nitride, and so on. The base 132 defines a ring-shaped assembling groove 1321 surrounding the light source 14 on the top surface of the base 132. The assembling groove 1321 is used for assembling the lamp envelope 15 on the base 132. The base 132 further defines at least one though hole 1322 running through the top and bottom surfaces. The though hole 1322 is provided for an extension of a wire therethrough, wherein the wire is used for the electrical connection between the light source 14 and the driving circuit 12.

The fins 134 and the hollow post 136 are formed on the bottom surface of the base 132. The fins 134 are arranged surrounding the hollow post 136, and each of the fins 134 is connected to an outer surface of the hollow post 136. In the present embodiment, the fins 134 and the hollow post 136 are integrally formed with the base 132. The fins 134, the hollow post 136, and the base 132 can be made of a same material. An end of the hollow post 136 away from the base 132 is fixed to an end of the securing portion 112 away from the electrical connector 114. The driving circuit 12 has a large portion received in the hollow post 136; thus, the structure of the LED lamp can be compact and the volume of the LED lamp can be small.

The lamp envelope 15 is made of transparent or translucent plastic. The lamp envelope 15 is located on and connected with the base 132 wherein the lamp envelope 15 and the base 132 corporately define a receiving room 16. The lamp envelope 15 includes a connecting portion 152 connected to the base 132 of the heat sink 13, and a covering portion 154 connected to the connecting portion 152. The connecting portion 152 and the covering portion 154 are formed by plastic injection molding. The connecting portion 152 has a disk-shaped configuration with a central hole 151 and has a joint ring 1523 surrounding the central hole 151. A plurality of ears 1524 extend horizontally and outwardly from a bottom end of the joint ring 1523. The joint ring 1523 and the ears 1524 are disposed in the assembling groove 1321 of the heat sink 13 and can be secured to the base 132 by screws or clips. In this embodiment, the joint ring 1523 has an annular shape. The number of the ears 1524 is four, and the ears 1524 are evenly and symmetrically distributed at the bottom end of the joint ring 1523. A first positioning structure 1521 is formed on a top of the connecting portion 152. The first positioning structure 1521 is an annular protrusion protruding upwardly from the top of the connecting portion 152.

The covering portion 154 is hemisphere-shaped. The covering portion 154 includes a light incident surface 1542 and a light output surface 1543 opposite to the light incident surface 1542. The light incident surface 1542 is located at an inner side of the covering portion 154 and faces the heat sink 13. The light incident surface 1542 forms a plurality of lenses 17 therein. The plurality of lenses 17 are spaced from each other, and a protrusion is formed between two adjacent lens 17. The light output surface 1543 is smooth and located at an outer side of the lamp envelope 15. A second positioning structure 1541 is formed on a bottom of the covering portion 154 for matching with the first positioning structure 1521 of the connecting portion 152. The second positioning structure 1541 is an annular recess for fitly receiving the first positioning structure 1521 therein. The first and second positioning structures 1521, 1541 are engaged with each other to secure the connecting portion 152 and the covering portion 154 together. It is noted that, the first and second positioning structures 1521, 1541 can also be combined by a process of ultrasonic welding. The strength of the combined connecting portion 152 and the covering portion 154 by ultrasonic welding is substantially equivalent to that of an integral envelope. Compared with the envelope made by the process of blow molding, the connecting portion 152 and the covering portion 154 of the lamp envelope 15 made by the process of plastic injection molding have a high yield. In addition, since the lamp envelope 15 of the present disclosure is divided into two separate parts, namely, the connecting portion 152 and the covering portion 154, the connecting portion 152 can be joined with a covering portion 154 with a different shape than the shown to form a desired lamp envelope 15 having a different configuration. Hence, varieties of envelopes 50 with the same connecting portion 152 can be provided, and the inventory cost of the lamp envelope 15 can be decreased.

The light source 14 is directly mounted on the top surface of the base 132 and received in the receiving room 16. The light source 14 faces the light incident surface 1542. The light source 14 is electrically connected to a circuit (not shown) formed on the top surface of the base 132. Preferably, the circuit is formed on the top surface by plating.

In the present embodiment, the light source 14 includes five LED packages. It is understood that the number of the LED packages is not limited to the present embodiment.

In operation, light rays generated by the light source 14 enter into the lamp envelope 15 via the light incident surface 1542, and then travel out of the lamp envelope 15 via the light output surface 1543. The plurality of lenses 17 formed on the light incident surface 1542 of the lamp envelope 15 collect the incident light rays on the light incident surface 1542 of the lamp envelope 15. Moreover, the plurality of lens 17 are spaced from the LED packages whereby heat generated by the LED packages can be directly dissipated into an outer atmosphere and heat dissipating efficiency can be improved. The plurality of lens 17 can be integrally formed with the plastic injection molding, or formed by a machining after the plastic injection molding, such as hot embossing or sandblasting.

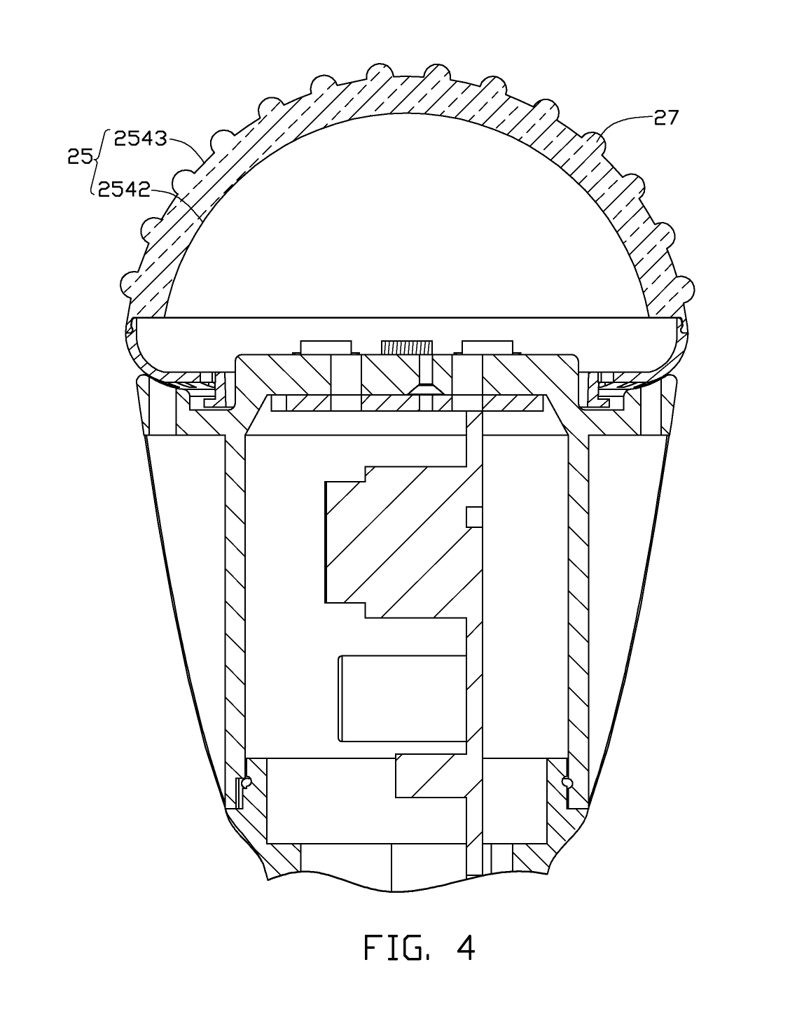

FIG. 4 shows an LED lamp according to an alternative embodiment. The difference lies in the lamp envelope 25. In this alternative embodiment, a light incident surface 2542 of the lamp envelope 25 is smooth, and a plurality of lenses 27 are formed on a light output surface 2543 of the lamp envelope 25.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A lamp envelope adapted for covering a light source of a lamp, the lamp envelope comprising a light incident surface facing the light source, and a light output surface opposite to the light incident surface, wherein a plurality of lenses are formed on the lamp envelope and configured for collecting light rays generated by the light source.

2. The lamp envelope of claim 1, wherein the plurality of lens are formed in the light incident surface, and the light output surface is smooth.

3. The lamp envelope of claim 1, wherein the plurality of lens are formed in the light output surface, and the light incident surface is smooth.

4. The lamp envelope of claim 1, wherein the lamp envelope consists of a connecting portion and a covering portion, the covering portion being separately formed from the connecting portion and combined with the connecting portion, the light incident surface and the light output surface being formed on the covering portion.

5. The lamp envelope of claim 4, wherein the connecting portion and the covering portion are made of plastic and formed by a process of plastic injection molding.

6. The lamp envelope of claim 4, wherein the connecting portion and the covering portion are combined together by a process of ultrasonic welding.

7. The lamp envelope of claim 4, wherein the connecting portion forms a first positioning structure thereon, the covering portion forms a second positioning structure thereon for matching with the first positioning structure.

8. The lamp envelope of claim 1, wherein the lamp envelope is formed by plastic injection molding and the plurality of lens are integrally formed by the plastic injection molding.

9. The lamp envelope of claim 1, wherein the lamp envelope is formed by plastic injection molding and the plurality of lens are formed by a machining after the plastic injection molding, which includes one of hot embossing and sandblasting.

10. An LED lamp comprising:
a lamp holder configured for electrically connecting with a power source;
a heat sink connected to the lamp holder;
a light source mounted on the heat sink; and
a lamp envelope mounted on the heat sink and covering the light source, the envelope having a light incident surface facing the light source and a light output surface opposite to the light incident surface, wherein a plurality of lens are formed on the lamp envelope and configured for collecting light rays generated by the light source.

11. The LED lamp of claim 10, wherein the plurality of lens are formed in the light incident surface, and the light output surface is smooth.

12. The LED lamp of claim 10, wherein the plurality of lens are formed in the light output surface, and the light incident surface is smooth.

13. The LED lamp of claim 10, wherein the envelope comprises a connecting portion and a covering portion, the covering portion is separately formed from the connecting portion and combined with the connecting portion, and the light incident surface and the light output surface are formed on the covering portion.

14. The LED lamp of claim 13, wherein the connecting portion and the covering portion are made of plastic and formed by a process of plastic injection molding.

15. The LED lamp of claim 13, wherein the connecting portion and the covering portion are combined together by a process of ultrasonic welding.

16. The LED lamp of claim 13, wherein the connecting portion forms a first positioning structure thereon, the covering portion forms a second positioning structure thereon for matching with the first positioning structure.

17. The LED lamp of claim 13, wherein the connecting portion comprises a joint ring surrounding a central hole thereof, the joint ring being secured to the heat sink.

18. The LED lamp of claim 17, wherein a plurality of ears are formed on a bottom end of the joint ring and secured to the heat sink.

19. The LED lamp of claim 10, wherein the light source comprises a plurality of LEDs.
